(19) United States
(12) Patent Application Publication
(10) Pub. No.: US 2023/0242042 A1
(43) Pub. Date: Aug. 3, 2023

(54) OVERHEAD CONSOLE AND VEHICLE

(71) Applicant: BCS AUTOMOTIVE INTERFACE SOLUTIONS US LLC, Wilmington, DE (US)

(72) Inventors: Richard Kukucka, Ann Arbor, MI (US); Steven Michael Lockhart, Clawson, MI (US)

(21) Appl. No.: 17/649,684

(22) Filed: Feb. 2, 2022

(51) Int. Cl. B60R 7/04

(52) U.S. Cl. CPC B60R 7/04

(57) ABSTRACT

An overhead console configured for being attached to a vehicle roof is provided, wherein at least one extendable storage compartment is integrated in the overhead console, a panel of which being arranged on a lateral or rear side of the overhead console, and wherein the storage compartment is linearly extendable in a horizontal direction when the overhead console is attached to the vehicle roof. Furthermore, a vehicle with a vehicle roof and an overhead console is provided.

### FIELD OF THE DISCLOSURE

The present invention refers to an overhead console configured for being attached to a vehicle roof and a vehicle with a vehicle roof and an overhead console that is attached to the vehicle roof.

### BACKGROUND

Overhead consoles for vehicles are a common part in many vehicles. Overhead consoles usually serve to accommodate various components such as lights, sensors, compartments etc.

The components which are manually operated by a vehicle occupant are usually accessible at a lower surface of the overhead console.

To accommodate all desired components, the overhead console has to be of a certain size. However, especially when the overhead console is attached to a panoramic glass roof, a large overhead console is disadvantageous because it causes a shadowing effect.

### SUMMARY

It is thus an object of the invention to provide an overhead console which is compact in size, especially covers an area of the vehicle roof that is as small as possible, but still provides enough space for objects to be accommodated.

This object is achieved by an overhead console configured for being attached to a vehicle roof, wherein at least one extendable storage compartment is integrated in the overhead console, a panel of which being arranged on a lateral or rear side of the overhead console, and wherein the storage compartment is linearly extendable in a horizontal direction when the overhead console is attached to the vehicle roof.

By means of a panel of the storage compartment being arranged on a lateral or rear side of the overhead console, the installation space of the overhead console is made use of in a more efficient manner. Thereby, size of the overhead console, in particular the required installation area of the overhead console on the vehicle roof, is kept small. Thus, a shadowing effect of the overhead console is reduced, especially in vehicles with panoramic glass roofs. Moreover, a compact design is also advantageous with respect to material input, thereby reducing the manufacturing costs.

In particular, it is the core idea of the present invention to optimize the usage of space in the overhead console, e.g. using a limited space in a most efficient manner.

By providing a linearly extendable storage compartment, a swing-out compartment, namely a hinged one, which is customary for storing glasses, can be omitted. This leaves a lower side of the overhead console available for other components. Moreover, the swivel movement requires more space compared to a linear sliding movement of the storage compartment.

The panel in particular forms a part of the surface of the overhead console when the storage compartment is closed.

The storage compartment is for example a drawer.

In fact, guidance members may be provided at lateral sides of the overhead console along which the storage compartment can slide in a linear manner.

According to one aspect, the storage compartment is coupled with an electric drive for extending and retracting the storage compartment. In particular, the electric drive is a linear drive. By providing an electric drive, the storage compartment is linearly extendable in an automatic manner, whereby a high level of comfort for a vehicle occupant is achieved.

For example, a touch sensor for actuating the electric drive is arranged on the overhead console. By actuating the touch sensor, a vehicle occupant may open the storage compartment particularly easy, e.g. in an automatic manner since the touch sensor controls the electric drive.

The touch sensor may be located at a well accessible location.

For example, the touch sensor is arranged on the panel of the overhead console. A vehicle occupant may thus open the storage compartment by touching the panel of the storage compartment, which is rather intuitive. For instance, the touch sensor is located at an underside of the overhead console, namely the side of the overhead console, which faces away from the roof of the vehicle.

According to a further aspect, a manually operated mechanism for extending and retracting the storage compartment is provided. Thereby, the mechanism for moving the storage compartment is kept simple and no electrical energy is required. Thus, the storage compartment may be extended or retracted even if the electric system of the vehicle is shut down.

The manually operated mechanism for example corresponds to a spring-loaded mechanism, a push-push mechanism or a cardioid mechanism, also called heart-curve mechanism. These mechanisms are operable in an easy manner. For example, the vehicle occupant can operate the mechanism by just pressing the panel of the storage compartment, thereby actuating the respective mechanical mechanism.

According to a further aspect, the overhead console may comprise an electric drive as well as a manually operated mechanism for opening the storage compartment.

According to one embodiment, a bottom wall of the storage compartment, which faces away from the vehicle roof in its attached state, is perforated. Thus, when the storage compartment is in its extended, open condition, light may pass through the bottom of the storage compartment, such that a shadowing effect of the storage compartment is reduced. Moreover, the passenger or driver of the vehicle can easily verify whether objects are located in the storage compartment or not.

An inner surface on the bottom wall of the storage compartment, which limits a compartment space of the storage compartment, may be provided with an anti-slip coating. Thereby, it is avoided that objects that are stored in the storage compartment slip out when the storage compartment is linearly moved.

For example, due to the anti-slip coating, side walls of the storage compartment are not necessary. This is advantageous because the storage compartment is easily accessible.

In other words, the storage compartment may correspond to a drawer tray.

For example, a light sensor, a rain sensor, a loudspeaker, a microphone, a lighting, a camera, a transponder, a knob, a button, a switch and/or a touchpad are/is integrated in the overhead console. Thus, a variety of functions and features may be integrated into the overhead console.

According to one embodiment, two adjacent storage compartments are provided. Thereby, a separate storage compartment is provided for a driver side and a passenger side of the vehicle.

A width of the storage compartment is for example maximally 300 mm and/or a length of the storage compartment is maximally 300 mm. Thereby, the storage compartment is big enough to receive common objects such as glasses and at the same time does not increase the size of the overhead console in a significant manner.

For example, the overhead console has a size of area of maximal 0.09 square meter. This size allows accommodating the necessary components in the overhead console without causing too much shadowing effect.

According to one aspect, the overhead console has a thickness of maximal 80 mm. The sight of a vehicle occupant to the side of the overhead console is therefore not restricted by it.

The object is further achieved by a vehicle with a vehicle roof and an overhead console that is attached to the vehicle roof, wherein the overhead console comprises at least one extendable storage compartment, a panel of which being arranged on a lateral or rear side of the overhead console, and wherein the storage compartment is linearly extendable in a horizontal direction when the overhead console is attached to the vehicle roof. As already mentioned with respect to the inventive overhead console, the vehicle has the advantage that the usage of space in the overhead console is optimized.

According to one embodiment, the vehicle roof comprises a panoramic glass roof having an attachment zone for the overhead console, which covers an area of maximal 0.09 square meter. The attachment zone may be covered by the overhead console on a side limiting the inside of the vehicle compartment. For example, in the attachment zone, a black print is present on the panoramic glass roof.

### BRIEF DESCRIPTION OF THE DRAWINGS

Further features and advantages of the invention can be derived from the following description and from the enclosed figures. In the Figures:

FIG. 1 shows an inventive vehicle in a schematic view,

FIG. 2 shows an inventive overhead console in a bottom view, and

FIG. 3 shows the overhead console of FIG. 2 with an extended storage compartment.

### DETAILED DESCRIPTION OF THE DRAWINGS

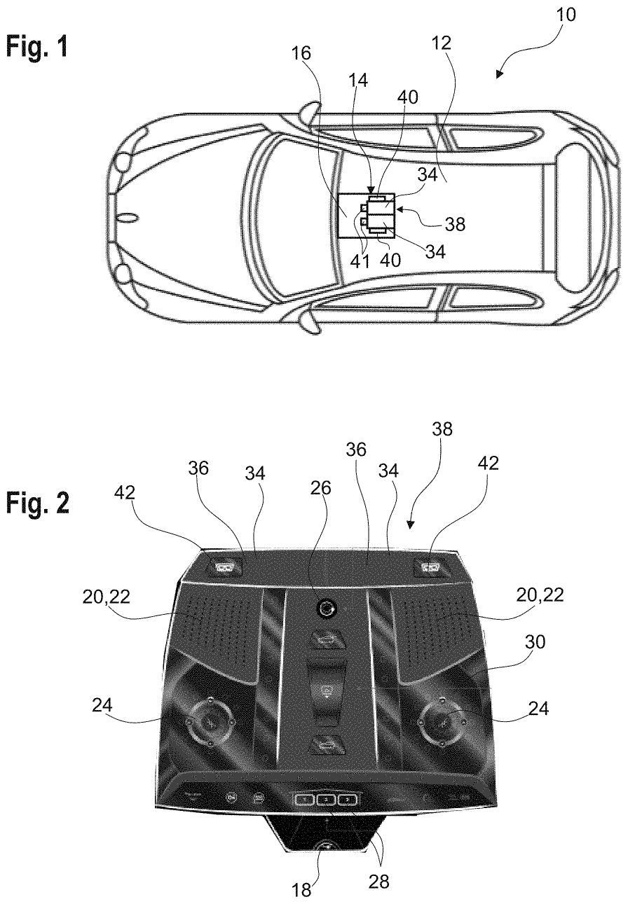

FIG. 1 schematically shows a vehicle 10 with a vehicle roof 12, which is a panoramic glass roof.

The vehicle roof 12 has an attachment zone 14 for an overhead console 16. In particular, the overhead console 16 is attached to the attachment zone 14 such that the attachment zone 14 is covered by the overhead console 16.

Generally, the overhead console 16 starts at the top of a windshield of the vehicle 10.

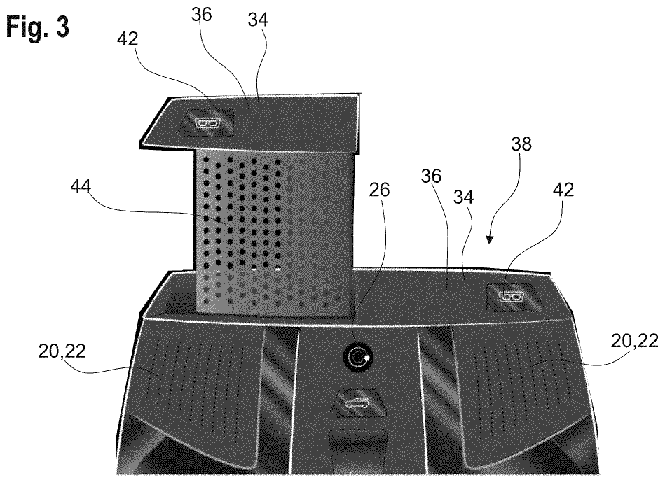

FIGS. 2 and 3 show the overhead console 16 in a view from below, namely on the underside of the overhead console 16.

Different components are integrated in the overhead console 16, such as a combined light and rain sensor 18, loudspeakers 20, microphones 22, lightings 24, a camera 26, different buttons 28 and a touchpad 30.

In a further embodiment, the light sensor may be separate from the rain sensor.

Additionally, a knob, a transponder (particularly in an integrated manner) and/or a switch which are not shown in the depicted embodiment may be integrated in the overhead console 16.

Moreover, two extendable storage compartments 34 are integrated in the overhead console 16. The two storage compartments 34 are adjacent to each other. In particular, one storage compartment 34 is assigned to a driver side and the other storage compartment 34 is assigned to a passenger side of the vehicle 10.

A panel 36 of each storage compartment 34 is arranged on a rear side 38 (see also FIG. 1) of the overhead console 16. However, the panel 36 may also be located on a lateral side of the overhead console 16.

In the closed state of the storage compartments 34 shown in FIG. 2, the panels 36 together with the rear side 38 establish a smooth surface. Put differently, the rear surface of the overhead console 16 that comprises the rear side 38 and the panels 36 may be flat. However, the rear surface may be inclined with respect to a horizontal line by an angle different to 90°.

Each storage compartment 34 is linearly extendable in a horizontal direction when the overhead console 16 is attached to the vehicle roof 12. FIG. 3 shows one of the storage compartments 34 in an extended condition.

In particular, the storage compartment 34 is extendable in a rearward direction when the overhead console 16 is attached to the vehicle roof 12.

To open and close the storage compartment 34, according to one embodiment an electric drive 40 for extending and retracting the storage compartment may be provided, which is visualized schematically in FIG. 1.

In the shown embodiment, the electric drive 40 is associated with a lateral side. This gives an indication that the storage compartment 34 may generally be moved in a direction along the vehicle length, namely from the left to the right, or rather perpendicular thereto, namely towards the vehicle side, e.g. to the top or bottom in FIG. 1.

As mentioned above, the respective panel 36 may be located on the rear side 38 of the overhead console 16 (movement along the vehicle length) or at one of the lateral sides of the overhead console 16 (movement to the respective side of the vehicle 10).

Generally, the electric drive 40 is fully integrated in the overhead console 16.

The electric drive 40 is for example a linear actuator. Linear actuators are commonly known, therefore a detailed description is refrained from.

For actuating the electric drive 40, a touch sensor 42 is arranged on the overhead console 16. In particular, the touch sensor 42 is arranged on the panel 36 of the overhead console 16.

The touch sensor 42 is for example a capacitive touch sensor.

Instead of providing an electric drive 40, a manually operated mechanism 41 for extending and retracting the storage compartment 34 may be provided, which is visualized schematically in FIG. 1. Generally, the storage compartments 34 shown in FIG. 1 when opened slide along the length of the vehicle 10 towards the rear of the vehicle 10.

It is also possible to provide the manually operated mechanism 41 additionally to the electric drive 40, such that the storage compartment 34 can also be opened when the electric system of the vehicle 10 is shut down.

The manually operated mechanism 41 for example corresponds to a spring-loaded mechanism, a push-push mechanism or a cardioid mechanism.

Such manually operated mechanisms are commonly known, thus a detailed description is refrained from.

As it is depicted in FIG. 3, a bottom wall 44 of the storage compartment 34, which faces away from the vehicle roof 12 in its attached state, is perforated. Due to the perforation, light falls through the storage compartment 34 when the compartment 34 is open.

An inner surface on the bottom wall 44 of the storage compartment 34, which limits a compartment space of the storage compartment 34, is provided with an anti-slip coating. In particular, the anti-slip coating is provided at a surface of the bottom wall 44 which is not visible in FIG. 3.

The overhead console 16 is compact in design, which is due to the optimized utilisation of space by means of the storage compartment 34. Also the storage compartment 34 itself has a compact design.

For example, a width of the storage compartment is maximally 300 mm and/or a length of the storage compartment is maximally 300 mm.

In particular, the overhead console 16 covers an area of typically 0.09 square meter.

The overhead console 16 for example has a thickness of maximal 80 mm.

1. An overhead console configured for being attached to a vehicle roof, wherein at least one extendable storage compartment is integrated in the overhead console, a panel of which being arranged on a lateral or rear side of the overhead console, and wherein the storage compartment is linearly extendable in a horizontal direction when the overhead console is attached to the vehicle roof.

2. The overhead console according to claim 1, wherein the storage compartment is coupled with an electric drive for extending and retracting the storage compartment.

3. The overhead console according to claim 2, wherein a touch sensor for actuating the electric drive is arranged on the overhead console.

4. The overhead console according to claim 3, wherein the touch sensor is arranged on the panel of the overhead console.

5. The overhead console according to claim 1, wherein a manually operated mechanism for extending and retracting the storage compartment is provided.

6. The overhead console according to claim 5, wherein the manually operated mechanism corresponds to a spring-loaded mechanism, a push-push mechanism or a cardioid mechanism.

7. The overhead console according to claim 1, wherein a bottom wall of the storage compartment, which faces away from the vehicle roof in its attached state, is perforated.

8. The overhead console according to claim 1, wherein an inner surface on the bottom wall of the storage compartment, which limits a compartment space of the storage compartment, is provided with an anti-slip coating.

9. The overhead console according to claim 1, wherein a light sensor, a rain sensor, a loudspeaker, a microphone, a lighting, a camera, a transponder, a knob, a button, a switch and/or a touchpad are/is integrated in the overhead console.

10. The overhead console according to claim 1, wherein two adjacent storage compartments are provided.

11. The overhead console according to claim 1, wherein a width of the storage compartment is maximally 300 mm and/or a length of the storage compartment is maximally 300 mm.

12. The overhead console according to claim 1, wherein the overhead console has a size of area of maximal 0.09 square meter.

13. The overhead console according to claim 1, wherein the overhead console has a thickness of maximal 80 mm.

14. A vehicle with a vehicle roof and an overhead console that is attached to the vehicle roof, wherein the overhead console comprises at least one extendable storage compartment, a panel of which being arranged on a lateral or rear side of the overhead console, and wherein the storage compartment is linearly extendable in a horizontal direction when the overhead console is attached to the vehicle roof.

15. The vehicle according to claim 14, wherein the vehicle roof comprises a panoramic glass roof having an attachment zone for the overhead console, which covers an area of maximal 0.09 square meter.
